(19) United States
(12) Patent Application Publication
(10) Pub. No.: US 2020/0067142 A1
(43) Pub. Date: Feb. 27, 2020

(54) Lithium Ion Accumulator In Sandwich Design And Method For The Production Thereof

(71) Applicant: Siemens Aktiengesellschaft, Munchen (DE)

(72) Inventors: Christian Doye, Berlin (DE); Jens Dahl Jensen, Berlin (DE); Ursus Krüger, Berlin (DE); Gabriele Winkler, Berlin (DE)

(73) Assignee: Siemens Aktiengesellschaft, München (DE)

(21) Appl. No.: 16/547,846

(22) Filed: Aug. 22, 2019

(30) Foreign Application Priority Data
Aug. 23, 2018 (EP) 18190360.0

(51) Int. Cl. H01M 10/0585; H01M 10/0525; B33Y 80/00

(52) U.S. Cl. CPC H01M 10/0585; B33Y 80/00; H01M 10/0525

(57) ABSTRACT

Various embodiments include a method for producing a lithium ion accumulator having an electrolyte with a cathode and an anode separated from the cathode by a separator, the method comprising: providing a first collector as a negative terminal of the accumulator at the anode; providing a second collector as a positive terminal of the accumulator at the cathode; arranging the anode and the cathode laterally next to one another between the positive terminal and the negative terminal; and separating the anode and the cathode from one another with the electrolyte and the separator. The accumulator is configured as a sandwich structure, the respective outer levels of which are formed by the negative terminal and the positive terminal.

### CROSS-REFERENCE TO RELATED APPLICATIONS

This application claims priority to EP Application No. 18190360.0 filed Aug. 23, 2018, the contents of which are hereby incorporated by reference in their entirety.

### TECHNICAL FIELD

The present disclosure relates to lithium ion accumulators.

### BACKGROUND

Lithium ion accumulators are used in modern portable electronic devices (cell phones, tablets, notebooks), and in modern vehicle technology (automobile, aircraft) as well as in aerospace technology. Compared with other battery types, lithium ion accumulators have a high energy density, a high power density and a high rated voltage, as well as a larger number of possible charging cycles before the accumulator loses power and capacity.

In other to operate automobiles and aircraft, a further increase in the energy density and power density would be desirable, in order on the one hand to reduce the weight of the accumulators and on the other hand to extend the range of the aforementioned means of transport.

In order to be able to produce lithium ion accumulators (also referred to below as accumulators for brevity), various manufacturing methods are known. In the recent past, additive manufacturing methods in particular have also been described for the production of lithium ion accumulators constructed in a layer-like fashion. In this case, the additive manufacturing methods fused deposition modeling (FDM) and fused filament fabrication (FFF) may preferably be used.

At the 231^{st} ECC (Meeting), on Oct. 4, 2017, a typical structure for a lithium ion accumulator in sandwich design was proposed. According to one example, this could be fitted in a temple stem in order to supply an application in the spectacles with electrical current. The sandwich structure consists of a layer sequence consisting of a collector, a cathode, a separator, an anode, a further collector and the housing, which is provided by the temple stem.

Conventional lithium ion accumulators are constructed two-dimensionally (i.e. layer by layer, the thickness of the layers being small in relation to the surface extent), and consist of anodes, cathodes and separators. In this case, the electrodes and separators are either stacked layerwise with, or wound with, the mutually parallel components. Electrochemically active materials are ground and subsequently mixed with a binder (usually PVDF, polyvinylidene fluoride) and carbon black. This mixture is dispersed in a dispersing agent, for example N-methyl-2-pyrrolidone (NMP), to form a slurry. This slurry is subsequently spread or rolled onto an electrically conductive carrier material (copper for the anode, aluminum for the cathode). The spread slurry is dried so that the dispersing agent evaporates. After drying, a calendering process is carried out, during which the surface is compressed and smoothed by rollers. The films comprising the active material are then cut to suitable sizes and may be used as electrodes. After stacking or winding, these electrodes are injected with an electrolyte containing lithium salt and subsequently packaged.

Thin-film electrodes, current collectors, separators, and solid electrolytes in the commercial film lithium batteries for microdevices are produced by sputtering or other evaporation methods. These processes and methods are known from the semiconductor and optical industries and include magnetron sputtering, pulsed laser deposition, electron beam evaporation and chemical vapor deposition. In this case, the length and width of these thin-film batteries are considerably (10 times) greater than the thickness, and the thickness is less than 0.5 mm.

Miniaturization of such lithium ion batteries with a simultaneous increase in the capacity is now achieved on the laboratory scale by a 3D printing method. Electrochemically active materials such as lithium iron phosphate (LFP) with carbon (graphene oxide or C-nanocrystal doped with Mn) as the cathode and lithium titanate composite Li₄Ti₅O₁₂ (LTO) as the anode are dispersed in a solution of deionized water, ethylene glycol, glycerol and a thickening agent based on cellulose. The two inks obtained in this way (LFP for the cathode and LTO for the anode) are applied by an extrusion-based 3D printing technology onto a glass substrate having current collectors. In this case, the particle dispersion is extruded continuously under pressure from a nozzle in order to produce a layer-based sandwich.

A solid electrolyte ink, which consists of poly(vinylidene fluoride-co-hexafluoropropylene) and Al₂O₃ nanoparticles is likewise printed between the anode and the cathode. This layer is both the electrolyte and the separator. With a size of 7 mm*3 mm and a layer thickness of 0.18 mm, the 3D lithium ion batteries produced to date in the laboratory have a capacity three times greater than a thin-film lithium ion battery with corresponding size and thickness. With an increase in the layer thickness, however, this performance gain is lost.

### SUMMARY

The teachings of the present disclosure describe methods for producing a lithium ion accumulator, and respectively the lithium ion accumulator itself, this lithium ion accumulator ensuring a maximally high capacity and power density with low weight. Various embodiments include a lithium ion accumulator comprising an electrolyte in which a cathode and an anode, separated from the cathode by a separator, are provided, a first collector being provided as a negative terminal of the accumulator at the anode, and a second collector being provided as a positive terminal of the accumulator at the cathode, the accumulator being configured as a sandwich structure, the respective outer levels of which are formed by the negative terminal and the positive terminal.

Some embodiments include a method for producing a lithium ion accumulator, comprising an electrolyte in which a cathode and an anode, separated from the cathode by a separator, are provided,
a first collector being provided as a negative terminal of the accumulator at the anode, and a second collector being provided as a positive terminal of the accumulator at the cathode,
the accumulator being configured as a sandwich structure, the respective outer levels of which are formed by the negative terminal and the positive terminal.

### BRIEF DESCRIPTION OF THE DRAWINGS

The exemplary embodiments explained below are only embodiments of the teachings and do not limit the scope of the present disclosure.

In the exemplary embodiments, the described components of the embodiments respectively represent individual features which are to be considered independently of one another, which respectively also refine the teachings independently of one another, and are therefore also to be regarded individually or in a combination other than that presented. Furthermore, the embodiments described may also be supplemented with other features among the features which have already been described. In the figures:

FIG. 1 schematically shows an exemplary embodiment of the lithium ion accumulator incorporating teachings of the present disclosure in a cross section,

FIG. 2 shows another exemplary embodiment of the lithium ion accumulator incorporating teachings of the present disclosure as a plan view, partially cut away,

FIG. 3 shows a further exemplary embodiment of the lithium ion accumulator incorporating teachings of the present disclosure in a three-dimensional representation, partially cut away,

FIGS. 4 to 9 show an exemplary embodiment of the method according to the invention for producing an exemplary embodiment of the lithium ion accumulator incorporating teachings of the present disclosure in various manufacturing steps,

FIG. 10 shows the lithium ion accumulator, which has been produced according to FIGS. 4 to 9, as a schematic cross section.

### DETAILED DESCRIPTION

For the accumulator specified in the introduction, the anode and the cathode are arranged laterally next to one another between the positive terminal and the negative terminal. Furthermore, the anode and the cathode are separated from one another by the electrolyte and the separator, this separation likewise existing between the anodes and the cathodes as seen in the lateral direction. The lateral direction is intended to be understood as a direction extending along the negative terminal and the positive terminal.

The negatively charged electrode gives the negative terminal. During discharge, this is the anode, while during charging it is the cathode. Accordingly, the positive electrode as the positive point is given by the cathode during discharge and the anode during charging. The collectors are in each case electrically conductively connected only to the cathode or only to the anode. They are therefore used for electrical connection of the individual structures which respectively form the cathode and the anode. This is necessary since the anode and the cathode consist of laterally alternating structures which must not be connected to one another.

The lateral arrangement of the anode and cathode provides a relatively high energy density of the accumulator even with larger overall heights. At the same time, the larger overall heights also allow a higher capacity of the accumulators (without thereby reducing the high permissible discharge currents). Since the substructures that respectively form the anode and the cathode extend perpendicularly to the positive terminal and the negative terminal, the distances which the electrical current must travel are respectively only at most as wide as the accumulator is thick. The situation is different with the layered accumulators according to the prior art, in which the anodes and cathodes alternate in the layer sequence. In that case, the contacting is substantially more problematic since layers located in the middle of the sandwich are difficult to drive electrically.

In some embodiments, the anode and the cathode are arranged laterally next to one another between the positive terminal and the negative terminal. Furthermore, the anode and the cathode are separated from one another by the electrolyte and the separator, by these being produced between the anode and the cathode. The structures produced in this way have the advantages described.

In some embodiments, the accumulator may be produced at least partially by an additive manufacturing method. In this way, even complicated three-dimensional structures may be produced, these then being oriented laterally in relation to the positive terminal and the negative terminal. The structures may, for example, have a meandering profile so that the interfaces between the anode and the cathode are advantageously increased. The electrolyte and the separator may be formed by a structure or a material.

In some embodiments, to increase the energy density, the surface areas of the energy-storing materials are increased. An increase in the surface area may be achieved by the geometrical and structural configuration of the electrodes of the carrier of the electrochemically active material. During the discharging and charging processes, the transport distance of the Li ions between the electrodes has an influence on the power of the accumulator.

If the distance increases, the power density decreases. This is the case when, in conventional lithium ion accumulators, which are constructed two-dimensionally, the energy density is improved by increasing the amount of active material by increasing the thickness of the electrodes. If, however, the electrodes are configured three-dimensionally, the transport distance of the lithium ions remains constant with an increasing electrode thickness, since these electrodes are arranged laterally next to one another.

In some embodiments, the surface area of the energy-storing materials may be increased by the three-dimensional geometrical configuration of the electrodes, i.e. of the carrier of the active material. In some embodiments, the construction of the electrodes is carried out by a combination of different generative manufacturing methods. Accordingly, some embodiments include methods wherein:
the anode and the cathode are produced laterally next to one another between the positive terminal and the negative terminal, and
the anode and the cathode are separated from one another by the electrolyte and the separator. The electrolyte and the separator may be formed by a structure or a material.

If shaping of the current collectors is not required, the electrochemically active electrodes may also be printed onto a copper and/or aluminum foil. Otherwise, the current collectors may be manufactured by a selective laser melting (SLM) method and/or a (selective) electron beam melting ((S)EBM)) method. Aluminum or copper in powder form is applied in a layer onto a base plate. Subsequently, the applied powder is fully locally melted by means of a laser beam and/or electron beam, and after solidification forms a solid metal layer. The base plate is lowered by the value of the layer thickness and powder is again applied; this is repeated until the layers are respectively thick enough. The solidified collector is cleaned of excess powder and immediately processed further. Layer thicknesses from 15 to 500 μm are possible, i.e. the current collector may already be completed after about two to three cycles. Since the data for guiding the laser beam and/or the electron beam are generated from a 3D CAD body by means of software (so-called slices), there is a large geometrical freedom of the electrode shape. In some embodiments, the copper foil may also be produced electrolytically by means of electroforming.

In some embodiments, the energy-storing and electrochemically active electrodes may be applied seamlessly onto the current collectors by means of fused deposition modeling (FDM), also referred to as fused filament fabrication (FFF). Before this, the chemically active substances (for the anode with lithium-coated graphite, graphene or coated carbon nanotubes, and for the cathode electrically conductive titanium dioxide needles in the nano-range, which are coated with LiFePO₄ or LiCoPO₄) are incorporated in an injection-moldable binder which consists of a thermoplastic (for example polyvinylidene fluoride, PVDF, or acrylonitrile-butadiene-styrene, ABS), and processed to form injection-moldable plastic filaments.

During the FFF or FDM method, 3D CAD data formats of a workpiece or model are processed. The 3D model is decomposed by a computer program into a multiplicity of layers (slices). These layers are applied by an extruder onto the current collectors. To this end, the plastic filaments are mounted in a heatable nozzle, liquefied, pressed out under pressure (extrusion) and applied onto the current collectors according to the layers of the 3D model. The applied plastic cools and hardens. The next layer of the liquid plastic is applied onto the hardened layer. The real image of the 3D model is thus formed layer by layer. Since the data for guiding the extruder are generated from a 3D CAD model by means of software, there is a large geometrical freedom of the electrode shape. The FFF method may also be carried out with exclusion of atmospheric oxygen, under a protective gas atmosphere (nitrogen or argon). In this case, the electrochemically active materials are protected against oxidation and the adhesion of the printed layers to one another is improved.

In some embodiments, a plurality of anodes and cathodes form a stack which is oriented perpendicularly to the first collector and the second collector, the electrolyte and the separator being arranged between the anodes and the cathodes. Such a stack may be produced very simply. In particular, such a stack may be produced by an additive manufacturing method. Once the stack has been completed, it may be covered with the negative terminal and the positive terminal so that these two terminals contact the respective end sides of the individual levels of the stack. This contacting is carried out in such a way that the cathodes are electrically coupled to the positive terminal and the anodes are electrically coupled to the negative terminal (during battery operation).

The stack design allows relatively uncomplicated manufacture and, at the same time, the production of accumulators with a high power density. The packing of cathodes and anodes may in this case be configured for an optimal surface ratio, so that accumulators with an increased power density can be produced. In some embodiments, a plurality of anodes and cathodes form columns which are oriented perpendicularly to the first collector and the second collector. In this case, the anodes and cathodes are arranged in a checkerboard pattern with respect to one another. The electrolyte and the separator are arranged between the anodes and the cathodes. By virtue of the checkerboard arrangement pattern, increased areas may be obtained between the anode and the cathode, so that the power density of the accumulator produced can be increased. Manufacture is straightforwardly possible in particular by means of additive manufacturing methods because of the large latitude.

In some embodiments, the cathode and/or the anode extend from the positive terminal to the negative terminal, an insulation layer being provided between the cathode and the negative terminal and/or between the anode and the positive terminal. This ensures that the cathode is electrically connected only to the positive terminal and the anode is electrically connected only to the negative terminal. Error-free functioning of the accumulator is ensured in this way. At the same time, it is possible that the respective end sides of the anode and cathode extending perpendicularly to the positive terminal and the negative terminal can be fully covered respectively by the positive terminal and the negative terminal, which significantly simplifies manufacture. The insulation layers in this case respectively ensure reliable insulation respectively from that electrode of the accumulator which is not intended to be contacted with the terminal in question.

In some embodiments, an infill structure made of an infill material is spatially distributed in the accumulator. In this way, three-dimensional structures of anodes and cathodes can be interleaved with one another, the infill structure (or filler structure), which may be made of an electrically insulating material, being located between the anode and the cathode structures. In particular, this may be provided in regions which are not intended to be, or cannot be, filled with the electrolyte and the separator. The three-dimensional structures of the anode and cathode advantageously lead to improved conduction of the current inside the accumulator and to an increase of the interface between the anode and the cathode. In this case, the power density that can be achieved with the accumulator in question may be further increased.

In some embodiments, the first collector and/or the second collector are produced from a metal, in particular copper or aluminum, by a powder-based additive manufacturing method, in particular selective laser melting and/or electron beam melting. The collectors may form both the positive terminal and the negative terminal. They therefore collect the current which flows because of the electron deficit or excess in the anode or the cathode, respectively, so that simple electrical contacting of the accumulator is possible.

In some embodiments, the anode and/or the cathode and/or the separator and/or the electrolyte and/or the insulation layer are produced by fused deposition modeling (FDM) or fused filament fabrication (FFF). These are additive manufacturing methods with which polymeric materials can be processed well, which is of great advantage for production of the aforementioned substructures of the accumulator.

In some embodiments, the first collector and/or the second collector are produced from a metal foil, in particular from copper or aluminum. This is an alternative manufacturing method, according to which an additive method is not used for the collectors, which have a comparatively simple structure, but instead economically available semifinished products are used. These may for example be connected to the anodes and the cathodes, so that electrical transmission of the current is possible. Since an insulation layer is thus required when such transmission is not intended to take place, the adhesive may be formed from an electrically insulating material. In particular, transmission of the electrical current from the cathode to the positive terminal and from the anode to the negative terminal may respectively be ensured by a pattern of electrically conductive and electrically insulating adhesives.

Further advantages of an additively produced (printed) lithium ion accumulator in comparison with a conventional two-dimensional design will be explained below.
Enlargement of the electrode surface area for comparable spatial conditions, therefore increasing the active surface areas by spatial interleaving of the individual components of the accumulator.
Uniform distribution of the active materials in the binder during FFF compared with a slurry which needs to be rolled or spread onto a carrier.
The printed lithium battery is manufactured in one piece. The stacking or winding of the individual films for the electrodes, current collectors and separators is obviated.
Injection of liquid electrolyte into the initial battery is obviated when the electrolyte is also printed.
Batteries of any thickness and size can be printed. The production of film lithium accumulators for micro-devices obviates the elaborate and expensive sputtering and evaporation methods which are derived from the semiconductor or optical industry.

Particular advantages of a printed Li battery with fused filament fabrication (FFF) over ink technology are as follows:
In the FFF method, no solvents such as water, ethylene glycol or glycerin, or thickening agents, are used which could impair the functioning of the accumulator.
During the printing, the active materials are distributed uniformly since they are incorporated into a plastic filament.
In the FFF method, the volume body is printed with a filling structure (infill). This means that, in addition to the shape change of the electrode from 2D to 3D, a surface enlargement may also be achieved by the infill pattern. By the infill structure, the electrode surface area per se is increased further. The fill factor of the volume body and the infill pattern are freely determinable. The pattern is generated using a 3D CAD model by software.
By the increase of the active energy-storing materials, the specific energy (in other words the energy density, units J per kg) of the accumulator is increased.
With the increase in the electrode area, the power density is reduced. The active material can be distributed over a larger surface and hot spots, which lead to short circuits, can be avoided. The explosion risk of the battery is therefore also reduced.
Since in 3D printing the current collectors, anode, separator, polymer electrolyte and cathode are joined seamlessly together, the internal resistance decreases and the charge transport can take place without hindrances.
In the printed 3D Li-ion accumulator, no liquid electrolyte is used, and therefore there is no evaporation of the electrolyte into the gas phase, no exposure of the electrolyte when the cells are opened, no ignition of the electrolyte when emerging from the cell, no reaction of the electrolyte when emerging from the cell.
By virtue of the enlargement of the electrode surface, materials can be used in the lithium ion accumulator which have a lower energy density but in turn are substantially safer even with varying temperatures. As a result of the temperature increase, there is then a lower risk of a battery fire, as well as of explosion due to an overpressure being formed inside the cell.
With the printed lithium ion accumulators, a contribution to digitization is made by the use of 3D CAD models. The accumulators may be designed easily according to customer wishes. Cells may be designed which operate as high-energy and high-power cells. As high-power cells, they can react very rapidly to the conversion of chemical into electrical energy and vice versa, since the transport paths of the lithium ions in the cell are short and constant.
Use of the printed lithium ion accumulators in modern vehicle technology (automobile, aircraft) by significant reduction of weight and therefore significant increase in range. Since the cells combine the two properties of a high energy density and a high power density, the energy generated from mechanical processes (friction, braking) can also be stored rapidly. A contribution is therefore also made to reducing the energy losses in modern vehicle technology.
With the printed accumulators, battery packs are constructed lighter and flatter and can therefore be stored in the doors and the floor of an automobile. In an aircraft, the flat battery packs may be fitted in the side walls of the passenger cabin, into the roof, and/or into the wings.
In railcar technology, electrical locomotives (streetcars and subways) may be equipped with printed lithium ion accumulators for emergencies. If there are lithium ion accumulators in the locomotives, track sections without an overhead wire and live rail may also be navigated. If, in winter, live rails are very heavily iced, streetcars may for example be operated with printed lithium ion batteries.
Printed lithium ion accumulators may also be used as static storage units in the electricity network for stabilization in the event of current variations, particularly when using renewable energies from wind and the sun. 2^{nd} life use as aircraft and electrical vehicle batteries is also possible.

Further details of the invention will be described below with the aid of the drawings. Drawing elements which are the same or correspond to one another are respectively provided with the same references and to this extent will be explained repeatedly only when differences arise between the individual figures.

FIG. 1 represents a lithium ion accumulator 11 (also referred to below as an accumulator 11 for brevity). It comprises a negative terminal M and a positive terminal P, which fulfill functions of collectors of the current. The positive terminal P and the negative terminal M are respectively provided with a contact 12 so that they can be externally contacted for discharging and charging. The accumulator is furthermore encapsulated in a housing 13 which protects the accumulator 11 and electrically insulates it externally.

The structure of the accumulator 11 is as follows. The anodes A and the cathodes K are respectively produced as a stack 14, the anodes A and the cathodes K alternating with one another and being respectively separated from one another by an electrolyte E.

Furthermore provided in the electrolyte E is a separator S which ensures functioning of the accumulator 11 by only allowing lithium ions to pass through it.

The stack 14 is layered in such a way that the individual levels of the stack (formed by anodes A, cathodes K, electrolyte E and separators S) extend perpendicularly to the profile of the collectors, i.e. of the negative terminal M and of the positive terminal P. This leads to the possibility that the current can respectively flow through the end sides of the cathodes and the anodes, so that the positive terminal P and the negative terminal M can conduct a high current. In this way, a high power density of the accumulator 11 can be drawn and is not limited by the fact that the current cannot be discharged from or delivered to the cathodes and the anodes rapidly enough. So that there is no short circuit in the accumulator 11, the end sides of the anodes A are separated by an insulation layer I from the positive terminal P, and the cathodes K are separated by an insulation layer I from the negative terminal M.

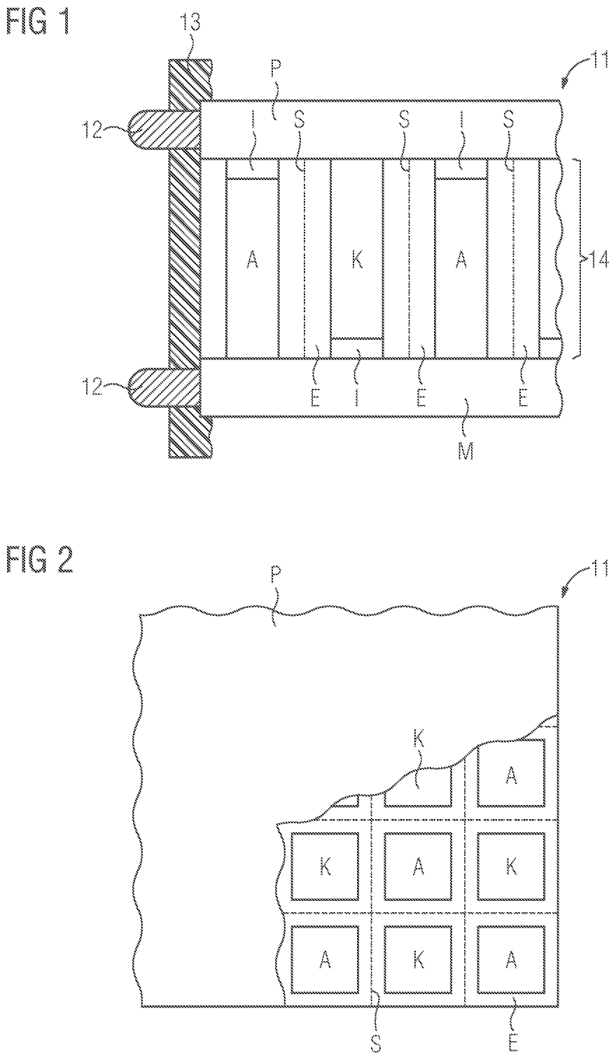

FIG. 2 represents another arrangement of the cathodes K and anodes A. These form a checkerboard pattern, that is to say the anodes and the cathodes alternate with one another, as can be readily seen in the plan view, in a similar way to the squares of a checkerboard (black-and-white). This gives rise to large transition surfaces for the lithium ions, the cathodes K and anodes A being surrounded in the form of a grid by the electrolyte E and the separator S. This gives rise to square cells, the capacity of the accumulator 11 being determined by the size of the checker square formed in this way and the height of the column-like cathodes K and anodes A.

FIG. 3 represents an accumulator 11 in which the anode A has a meandering profile. The cathode K is fitted in the intermediate spaces thus formed. It is additionally represented (see the dot-and-dash line) that cavities of the accumulator 11 may be filled with an infill structure IN (also referred to as a filler structure). This region is not to be filled by an element of the accumulator because of the three-dimensional structure, which is represented in FIG. 3, so that the resulting cavity may be filled with the infill structure.

It can furthermore be seen that the combination of electrolyte E and separator S likewise has a meandering profile. It therefore matches with the profile of the anode A and therefore reliably separates the anode from the cathode K lying in the meandering loops. Furthermore, the cathode K must be insulated by means of the insulation layer I from the negative terminal M. Likewise, an insulation layer I is provided which separates the positive terminal P from the anode A.

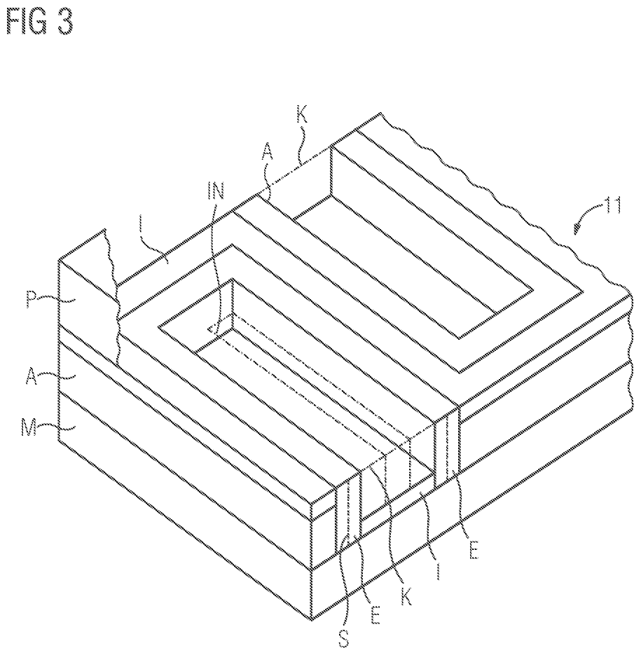

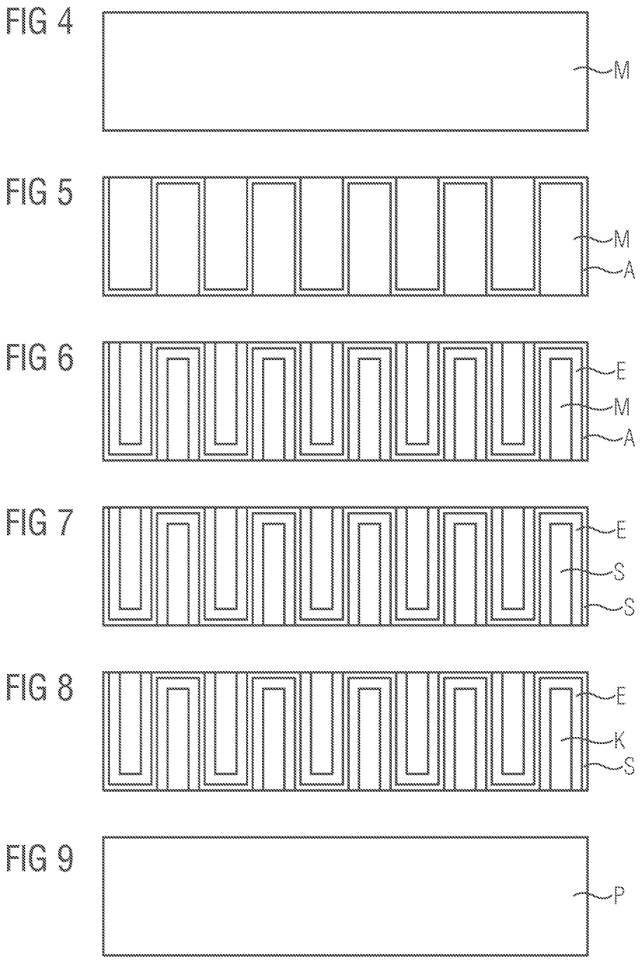

The following printing sequences for an exemplary embodiment of the method incorporating teachings of the present disclosure is represented according to FIGS. 4 to 9. On a copper foil as the negative terminal M (FIG. 4), which serves as a current collector, the anode A (PVDF with the electrochemically active materials) is printed by means of FFF according to a 3D CAD model in a plurality of levels (FIG. 5). Subsequently, the entire cathode surface is encapsulated with solid electrolyte E (FIG. 6). The solid electrolyte is likewise PVDF with a copolymer, poly(vinylidene fluoride-co-hexafluoropropylene), in which there are a lithium salt, for example lithium hexafluorophosphate or lithium tetrafluoroborate, and ceramic particles, for example aluminum oxide, zirconium oxide, silicon oxide or silicon carbide. The ceramic additives are intended to increase the stability of the solid electrolyte during operation with evolution of heat.

The solid electrolyte is likewise printed by means of FFF. Since unstructured metal foils are used as current collectors, a separator is also necessary for separating the cathode and anode spaces. In order to print the separator, polyethylene (PE), polypropylene (PP) or polyethylene terephthalate (PET) filaments, which contain ceramic materials (Al₂O₃, ZrO₂, SiC, SiO₂ or mixtures) in order to increase the thermal stability, may for example be used (FIG. 7). The separator is placed over the anode and that region of the copper foil which is not covered with anode and polymer electrolyte. The separator contains no electrically conductive components. The remaining free volume is filled with cathode material (PVDF with the chemically active material) (FIG. 8). To this end, the cathode material is likewise printed by means of FFF. An aluminum foil as a current collector for the cathode, which foil forms the positive terminal P, is subsequently laminated onto the cathode and polymer electrolyte surfaces (FIG. 9).

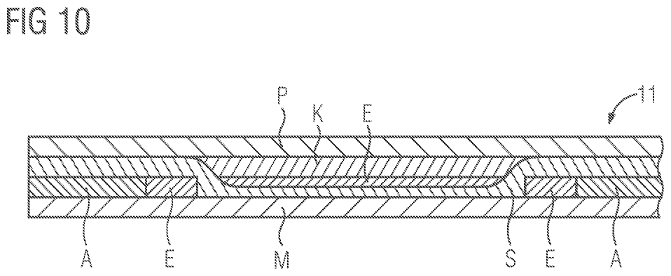

It can be seen in FIG. 10 that the method according to FIGS. 4 to 9 leads to a structure of the accumulator 11 which implements a kind of thin-film technology. It can be seen that, unlike in FIG. 3, the individual elements, i.e. anode A, cathode K, electrolyte E and separator S are made much thinner. There is, however, the same meandering profile for the anode A, as already described above with reference to FIG. 3 (this is also revealed by FIGS. 4 to 9). The separator is, however, selected in its profile so that it is at the same time used as an insulator for the positive terminal and the negative terminal. This is a difference from the represented arrangement according to FIG. 3.

### LIST OF REFERENCES

11 accumulator
M negative terminal
P positive terminal
12 contact
13 housing
A anode
K cathode
14 stack
E electrolyte
S separator
I insulation layer
IN infill structure

1. A lithium ion accumulator comprising:
an electrolyte;
a cathode disposed in the electrolyte;
an anode disposed in the electrolyte and separated from the cathode by a separator;
a first collector forming a negative terminal at the anode; and
a second collector forming a positive terminal at the cathode;
wherein respective outer levels of the accumulator form a sandwich structure of the negative terminal and the positive terminal;
wherein the anode and the cathode are arranged laterally next to one another between the positive terminal and the negative terminal.

2. The lithium ion accumulator as claimed in claim 1, wherein:
at least one of the anode and the cathode has a meandering profile; and
the cathode is interleaved laterally with the anode.

3. The lithium ion accumulator as claimed in claim 1, wherein a plurality of anodes and cathodes form a stack oriented perpendicularly to the first collector and the second collector; and
the electrolyte and the separator are disposed between the anodes and the cathodes.

4. The lithium ion accumulator as claimed in claim 1, wherein:
a plurality of anodes and cathodes form columns oriented perpendicularly to the first collector and the second collector;
each of the respective anodes and cathodes are arranged in a checkerboard pattern with respect to one another; and
the electrolyte and the separator are arranged between the anodes and the cathodes.

5. The lithium ion accumulator as claimed in claim 1, wherein at least one of the cathode and the anode extends from the positive terminal to the negative terminal;
further comprising an insulation layer between the cathode and the negative terminal and/or between the anode and the positive terminal.

6. The lithium ion accumulator as claimed in claim 1, further comprising an infill structure made of an infill material spatially distributed in the accumulator.

7. A method for producing a lithium ion accumulator having an electrolyte with a cathode and an anode separated from the cathode by a separator, the method comprising:
providing a first collector as a negative terminal of the accumulator at the anode;
providing a second collector as a positive terminal of the accumulator at the cathode;
wherein the accumulator is configured as a sandwich structure, the respective outer levels of which are formed by the negative terminal and the positive terminal;
arranging the anode and the cathode laterally next to one another between the positive terminal and the negative terminal; and
separating the anode and the cathode from one another with the electrolyte and the separator.

8. The method as claimed in claim 7, further comprising at least partially fabricating the lithium ion accumulator using an additive manufacturing method.

9. The method as claimed in claim 8, further comprising fabricating at least one of the first collector and the second collector from a metal using a powder-based additive manufacturing method.

10. The method as claimed in claim 8, further comprising fabricating at least one of the anode, the cathode, the separator, the electrolyte, and the insulation layer using fused deposition modeling or fused filament fabrication.

11. The method as claimed in claim 7, further comprising fabricating at least one of the first collector and the second collector from a metal foil.
